(19) United States
(12) Patent Application Publication
(10) Pub. No.: US 2013/0092285 A1
(43) Pub. Date: Apr. 18, 2013

(54) REFILLABLE LIQUID CARTRIDGE SYSTEM

(71) Applicant: EP Systems SA, Neuchatel (CH)

(72) Inventors: Amir Feriani, Auvernier (CH); Patrick Muller, Saint-Aubin sur Gaillon (FR); Jean-Paul Sandoz, Cormondreche (CH); Cédric Zaugg, Neuchatel (CH)

(73) Assignee: EP SYSTEMS SA, Neuchatel (CH)

(21) Appl. No.: 13/623,349

(22) Filed: Sep. 20, 2012

(30) Foreign Application Priority Data
Sep. 20, 2011 (EP) 11 182 025.4

(51) Int. Cl. B67D 7/02

(52) U.S. Cl. CPC B67D 7/0294
USPC 141/18

(57) ABSTRACT

A refillable liquid cartridge system includes: a docking cap (2) for controlling liquid flow from a main container (3) to a refillable cartridge (1), a refillable cartridge (1) for use as a portable spray device and mounted on the docking cap (2), a main container (3) for providing liquid contained therein to the refillable cartridge and mounted on the docking cap (2), and a power supply (26) for powering the docking cap (2). The docking cap (2) may include: a micro-pump system (23), and a system controller (25) operable to control the micro-pump. The micro-pump system (23) is operable to pump liquid from the main container (3) to the refillable cartridge (1) and to detect an empty state of the main container (3) and a full state of the refillable cartridge (1).

This application claims priority from European Patent Application No. 11182025.4, filed Sep. 20, 2011, the entire disclosure of which is incorporated herein by reference.

### FIELD OF THE INVENTION

The present invention relates to refillable cartridge systems for liquids, in particular for perfumes, cosmetics, medication, or the like. Generally, such liquids are sold in bottles that are too big and heavy to carry around in a lady's handbag. Also, current air traffic regulations only allow for a limited amount of liquid to be carried on board. Such bottles typically contain about 100 ml or more of liquid and are thus bulky, heavy and may not be allowed on an airplane. It is possible to manufacture smaller bottles, for example, of about 10 ml, that are portable and easily fit in a lady's handbag, but such smaller bottles are quickly used up, and the total costs become high, both for the manufacturer and for the consumer.

### BACKGROUND OF THE INVENTION

Refillable bottles or cartridges as they may be called hereafter are known as such. There are several systems on the market. For example, it is known to provide a standard-size perfume bottle together with a portable refill. A user can position the refill on the output of the standard-size bottles and pump manually by a reciprocal movement of the refill so as to fill the refill.

Clearly, such a solution is awkward. Further, it is not always easy to refill manually because the manual pumping is tedious and very restrictive for the user, mainly for non-technical usage requirements. Also, it is not always easy to judge if the refill has been fully filled or only partly filled, because even if the bottle may be transparent, the hand of the user manipulating it during the refill may hide the level of liquid in the refill. Furthermore, the manual filling may lead to overflow and, thus, spilling and waste of the liquid.

It is, therefore, an object of the present invention to provide an innovative filling system that overcomes the inconveniences presented by the prior art.

### SUMMARY OF THE INVENTION

Thus, the present invention concerns an innovative system fulfilling these objectives efficiently and which may be obtained in a relatively simple and inexpensive manner. The innovative system concerns generally a refillable liquid cartridge system that includes: (a) a docking cap (2) for controlling liquid flow from a main container (3) to a refillable cartridge (1), (b) a refillable cartridge (1) for use as a portable spray device and mounted on the docking cap (2), (c) a main container (3) for providing liquid contained therein to the refillable cartridge and mounted on the docking cap (2), and (d) a power supply (26) for powering the docking cap (2). The docking cap (2) may include: a micro-pump system (23), and a system controller (25) operable to control the micro-pump. The micro-pump system (23) is operable to pump liquid from the main container (3) to the refillable cartridge (1) and to detect an empty state of the main container (3) and a full state of the refillable cartridge (1).

In accordance with a more specific, but non-limiting first embodiment of the present invention, a refillable liquid cartridge system is provided that includes: (a) a docking cap (2) for controlling liquid flow from a main container (3) to a refillable cartridge (1), (b) a refillable cartridge (1) for use as a portable spray device and mounted on the docking cap (2), (c) a main container (3) for providing liquid contained therein to the refillable cartridge and mounted on the docking cap (2), and (d) a power supply (26) for powering the docking cap (2), characterised in that the docking cap (2) comprises a micro-pump system (23), and a system controller (25) operable to control the micro-pump, and in that the micro-pump system (23) is operable to pump liquid from the main container (3) to the refillable cartridge (1) and to detect an empty state of the main container (1) and a full state of the refillable cartridge (1). In accordance with a second non-limiting embodiment of the present invention, the first non-limiting embodiment is modified so that the micro-pump system (23) is operable to detect combined time dependant acoustic and mechanical vibrations generated by flow of liquid, and to provide electric signals to the system controller (25), and wherein the system controller (25) is operable to analyse the electrical signal in order to determine the state of the liquid flow.

In accordance with a third non-limiting embodiment of the present invention, the first and second non-limiting embodiments are further modified so that the refillable cartridge (1) is provided with a refill package (10) for receiving the refillable cartridge and adapted to fit into a refill dock (20) of the docking cap (2), and the main container is provided with a bottle neck (30) for receiving the main reservoir (3) and adapted to fit into a bottle dock (21) of the docking cap (2). In accordance with a fourth non-limiting embodiment of the present invention, the third non-limiting embodiment is further modified so that the refill package (10) comprises a first tag for identification of the refillable cartridge (1).

In accordance with a fifth non-limiting embodiment of the present invention, the third and fourth non-limiting embodiments are further modified so that the bottle neck (30) comprises a second tag for identification of the main container (3). In accordance with a sixth non-limiting embodiment of the present invention, the third, fourth and fifth non-limiting embodiments are further modified so that the first tag and the second tag are non-contact tags, and the docking cap further includes a non-contact tag reader (24) coupled to the system controller and operable to read the first and the second tag, and wherein the system controller (25) is operable to start the micro-pump system (23) as a function of the output of the non-contact tag reader (24). In accordance with a seventh non-limiting embodiment of the present invention, the third, fourth, fifth and sixth non-limiting embodiments of the invention are further modified so that the refill dock (20) comprises a refill fluidic interface (20′) having valve means for regulating liquid flow to the refillable cartridge (1), and wherein the bottle dock (21′) comprises a bottle fluidic interface (21) having valve means for regulating liquid flow from the main container (3).

In accordance with an eighth non-limiting embodiment of the present invention, the first, second, third, fourth, fifth, sixth, and seventh non-limiting embodiments are further modified so that the docking cap is provided with a visual indicator for indicating at least one of the state of the main container (3), the state of the refillable cartridge (1) and the state of the power supply (26). In accordance with a ninth non-limiting embodiment of the present invention, the first, second, third, fourth, fifth, sixth, seventh and eighth non-limiting embodiments are further modified so that the docking cap (2) further comprises a solar module (28) for generating power to recharge the power supply (26). In accordance with a tenth non-limiting embodiment of the present invention, the first, second, third, fourth, fifth, sixth, seventh, eighth and ninth non-limiting embodiments have been further modified so that the liquid is perfume. In accordance with an eleventh non-limiting embodiment of the present invention, the first, second, third, fourth, fifth, sixth, seventh, eighth, ninth and tenth non-limiting embodiments have been further modified so that the micro-pump system is a piezoelectric micro-pump system having a piezoelectric actuator.

Thanks to the features of the innovative system according to the present invention, a sure and simple system for easy and clean refilling of a refill cartridge may be obtained in a relatively simple and inexpensive manner.

### BRIEF DESCRIPTION OF THE DRAWINGS

Other features and advantages of the system according to the present invention will become clear from reading the following description, which is given solely by way of a non-limitative example, thereby referring to the attached drawings in which:

FIG. 1 shows an example of a refillable liquid cartridge system according to the present invention,

FIG. 2 shows an example of a refillable cartridge of the system shown in FIG. 1,

FIG. 3 shows an example of a principal container of the system shown in FIG. 1,

FIG. 4 shows an example of a docking cap of the system shown in FIG. 1,

FIG. 5 shows a flowchart showing the operation of the refillable cartridge check of the system according to the present invention, and

FIG. 6 shows a flowchart showing the operation of a micro-pump for pumping fluid from the main container to the refillable cartridge of the system according to the present invention,

FIG. 7 shows a time domain voltage and current of the micro-pump system used for controlling the refilling operation of the refilling in the system according to the present invention, and

FIG. 8 shows a band-passed envelope of the current analysis time-window of the micro-pump system used for controlling the refilling operation of the refilling in the system according to the present invention.

### DETAILED DESCRIPTION OF THE INVENTION

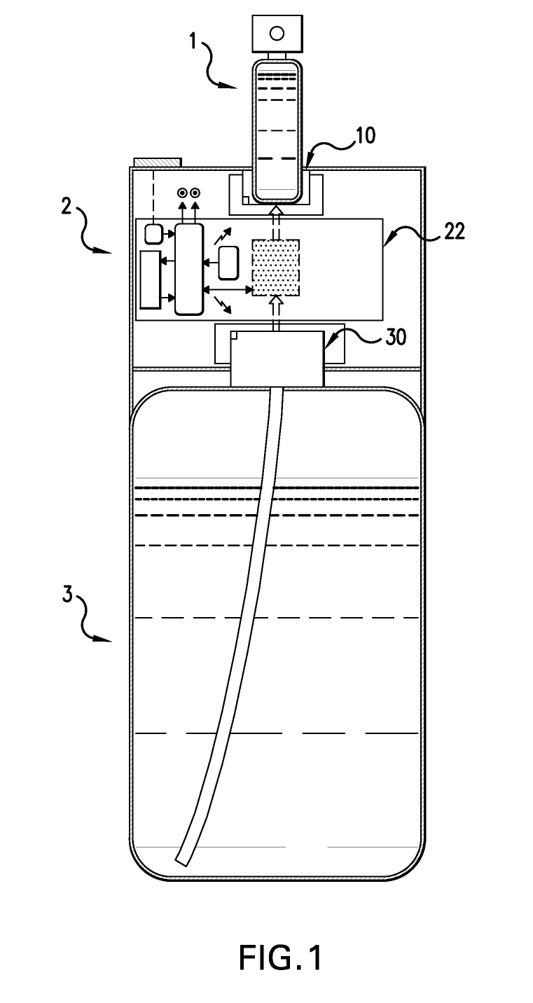

The present invention thus concerns a refillable liquid cartridge system. As shown in FIG. 1, the present system comprises three main parts: (a) a refill 1, which is a refillable cartridge and which may have, for example, a content of 5 to 20 ml, (b) a main container 3, for example, a regular perfume bottle that may have, for example, 100 ml contents or the like, and (c) a docking cap 2, or docking station, for receiving both refill 1 and container 3, and for providing liquid from container 3 to refill 1.

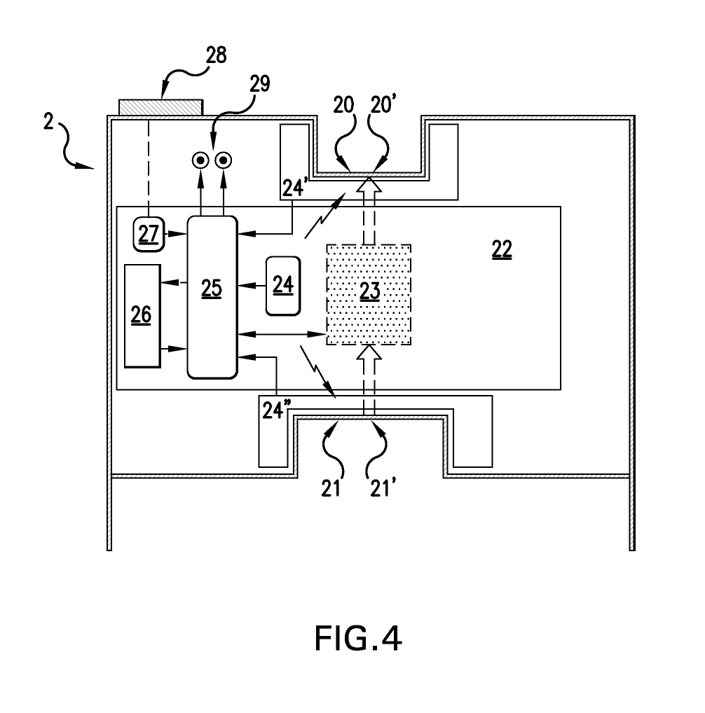

Refill 1 is provided with a refill package 10 for insertion into a dock 20 (see FIG. 4) suitably provided in docking cap 2. Refill 1 includes a distribution pump attached to the container for liquid dispensing. This container includes a mechanical valve at its bottom for liquid filling which is adapted to the refill fluidic interface 20′ suitably provided in docking cap 2.

Similarly, container 3, hereafter also referred to as a bottle, is provided with a bottle neck 30 for insertion into a dock 21 suitably provided in docking cap 2. Docking cap 2 contains an electronic circuit board 22 comprising components for controlling the liquid delivery from bottle 3 through bottle neck 30 to refill 1 by way of refill package 10.

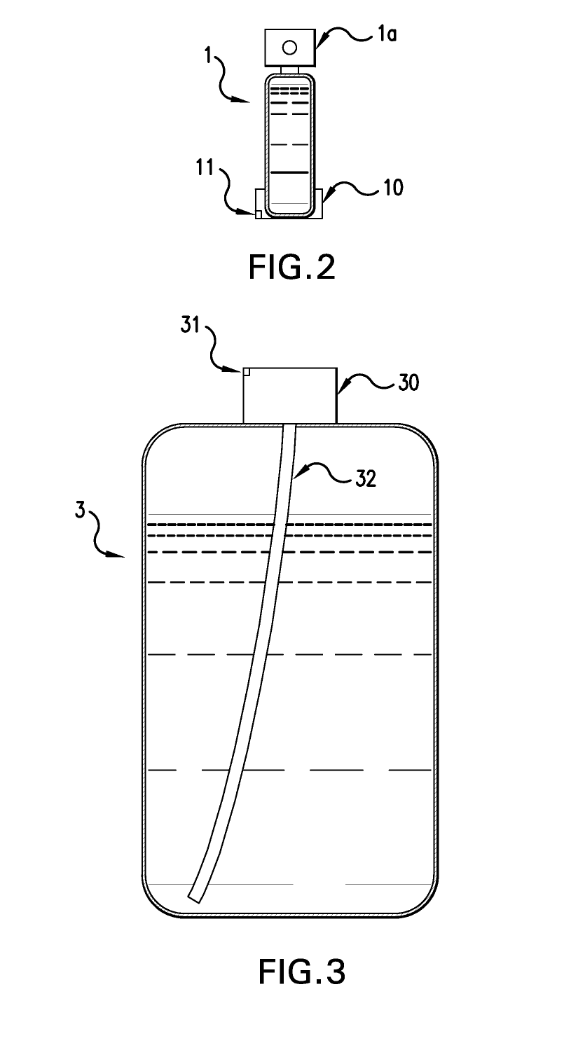

FIG. 2 shows in more detail refill 1. Refill 1 may be a small portable liquid reservoir that can easily be carried around and put into a lady's handbag. Refill 1 may be provided with a spray head la for ejecting liquid as a spray from the reservoir. A refill package 10 is provided that is fitted to the bottom of refill 1 and that is shaped to fit into dock 20 suitably provided in docking cap 2. Refill tag 11 for identifying refill 1 may be located in refill package 10 or may be embedded into refill 1.

To this effect, refill tag 11 is a non-contact tag as, for example, a radio frequency (RF), capacitive, inductive tag, or any other non-contact means of identification that is interrogated by suitable electronic control means on electronic circuit board 22 in docking cap 2, or it may be an electro-mechanical tag, or mechanical tag, so as to prevent insertion of refill 1 into docking cap 2 in order to avoid unwanted filling of refill 1 by liquid contained in bottle 3. For example, such refill tag 11 may prevent filling refill 1 of brand “X” with liquid from bottle 3 of brand “Y”.

FIG. 3 shows in more detail bottle 3. Bottle neck 30 is provided to be fitted to the top of bottle 3 and is shaped to fit into dock 21 suitably provided in docking cap 2. Bottle neck 30 may be provided with a bottle tag 31, similar to refill tag 11, for preventing unwanted transfer of liquid from bottle 3 to refill 1. A dip-tube 32 is provided in bottle 3 for extracting liquid from the bottle, in a manner known as such. Naturally, bottle 30 may be provided with a spray head for use of bottle 3 as a normal liquid dispenser.

FIG. 4 shows, in more detail, docking cap 2. Refill dock 20 contains a refill fluidic interface 20′, such as a valve means (valve), for regulating liquid flow to refill 1. Similarly, bottle dock 21′ contains a bottle fluidic interface 21 for regulating liquid flow from bottle 3. Electronic circuit board 22 comprises a micro-pump system 23 for pumping liquid from bottle 3 to refill 1. A system controller 25 controls micro-pump system 23 and is powered by a power supply 26, for example, a rechargeable or non-rechargeable battery. A non-contact tag reader 24, for example, a radio frequency identification (RFID) tag reader, may be provided for identifying the optional refill tag 11 and/or the bottle tag 31. Micro-pump system 23 is preferably an electromechanical micro-pump that acts as a bi-valve to regulate pumping of liquid into the micro-pump from bottle 3 and pumping of liquid from the micro-pump out to refill 1. Such an electromechanical pump thus converts electricity into mechanical energy and may be, for example, an electric pump, a gear pump, a peristaltic pump, a piezoelectric pump, or the like.

Advantageously, a solar module 28 may be provided on docking cap 2 and can be used for direct powering the electronic means on electronic circuit board 22, or for recharging power supply 26, or both. In such case, a power management circuit 27 may be provided for controlling the powering and/or charging of the power supply and of the electronic means on the circuit board.

Furthermore, one or more indicator lights 29 may be provided to indicate the status of power supply 26. Moreover, these indicator lights may also be provided to indicate the state of the liquid reservoir of bottle 3 and/or of refill 1.

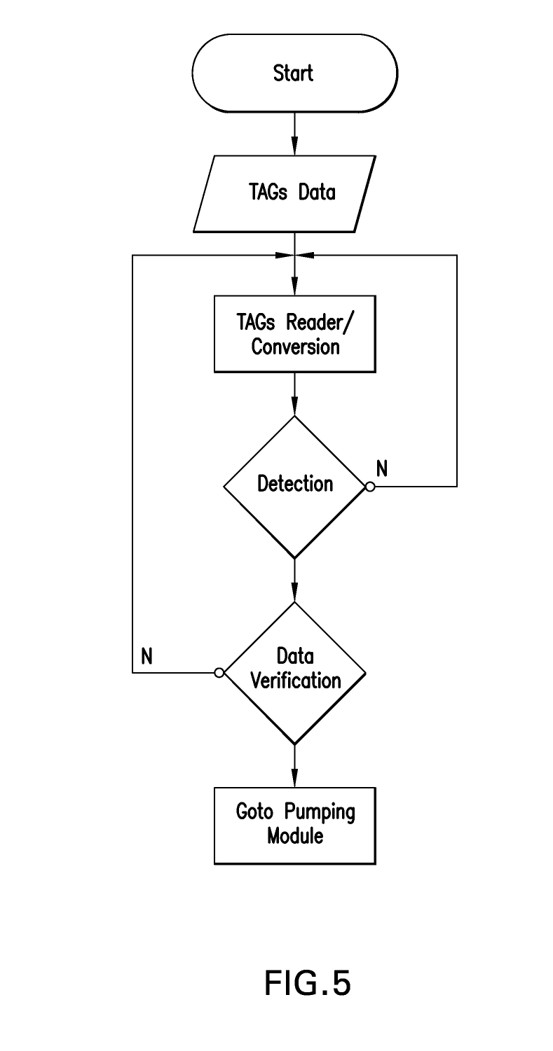

FIG. 5 shows a flowchart showing the operation process of the tag check of the system according to the present invention when such a tag is provided. First of all, the operation is started by non-contact tag reader 24 identifying the refill tag 11 and/or bottle tag 31. The information is processed and possibly converted so as to be suitable for comparison with pre-stored data, for example, in a Look-up table in tag reader 24. If the tag is not correctly detected, the process returns to analyse the available tag. If the tag is correctly identified, the identification information is verified with pre-stored data, or other means of discrimination. If the data verifies positively, pumping clearance is provided to system controller 25, if not the process goes back to identification possibly available tag.

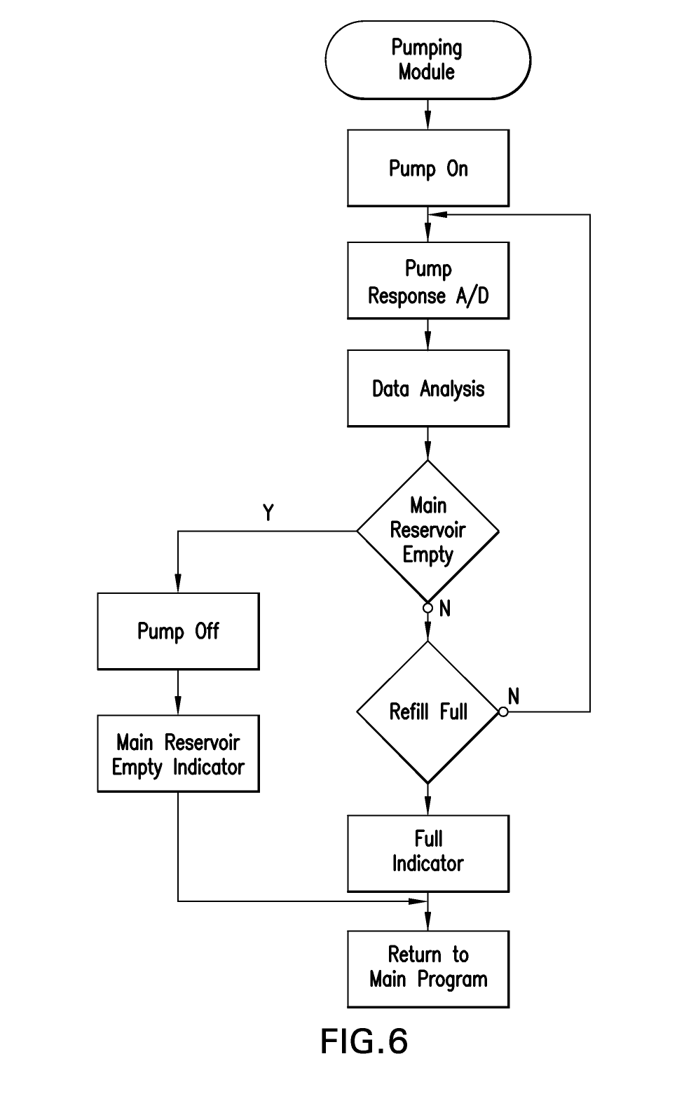

Once the identification has been positively verified, the system controller starts the pumping operation and controls micro-pump system 23. FIG. 6 shows the pumping module describing the operation process of the control of the micro-pump.

To start, the micro-pump is switched on. If a non-contact tag reader is present, this is done only after positive verification as explained above. Micro-pump system 23 pumps liquid from bottle 3 via bottle fluidic interface 21 into the pump and then pumps out the liquid into refill 1 via refill fluidic interface 20′. The basic operation of a micro-pump system is to open an input valve in fluidic connection with liquid input means, here the bottle fluidic interface 21, and to suck in a predetermined amount of liquid to fill a buffer space in the pump. Once the buffer space is filled, the input valve is closed. Then, an output valve, in fluidic connection with liquid output means, here the refill fluidic interface 20′, is opened and the liquid is pumped out of the buffer space into refill 1. This operation may continue as long as there is liquid in bottle 3, thus allowing for a continuous pumping operation.

In order to detect the presence of liquid in bottle 3, it is possible to analyse the presence of the flow of liquid from bottle 3 to micro-pump system 23. As an example, the band-passed filtered envelope analysis time window of the current of micro-pump 23 is representative of the presence of liquid in bottle 3. Thus, this operation of flow detection is carried out by the pump system itself and does not require additional sensors. As explained in patent document EP 2 216 100, a self-sensing dispensing device may comprise an electromechanical actuator, which is a piezoelectric actuator in the disclosed example, that may be used as a flow detector. In the present invention, micro-pump system 23 acts in a similar manner as a self-sensing flow detector.

In fact, by using the principle of elecromechanicity not only to convert electricity to mechanical movement, but also to convert mechanical perturbations back to electricity, micro-pump system 23 can be used to detect external characteristics, in this case liquid flow from the bottle, as such liquid flow naturally creates combined time dependent mechanical vibrations and ultrasonic pressure waves in the proximity of the micro-pump, which causes perturbation that can be picked up thus allowing detection of the liquid flow. By appropriate analysis of the electrical signals resulting from these two combined effects through system controller 25, it is possible to determine when the liquid flow starts and stops. It is then also possible to control, once the liquid is detected as started, the input valve of the micro-pump so that liquid may be provided from bottle 3 to refill 1. The cited document EP 2 216 100 explains how the analysis can be carried out. In summary, the acoustic-mechanical effect of the liquid flowing or not flowing will show up in the by micro-pump system 23 generated electric signals and characteristic impedances. Thus, it is possible to apply detection techniques to determine if a liquid flow is considered to be in progress. Therefore, the start and stop can be differentiated by an appropriate signal processing technique, as, for example, band-pass filtering of the current at an appropriate frequency.

As explained with reference to FIG. 6, once the pumping process has started, signals from the micro-pump system 23 are converted from analog to digital prior to their processing. This analysis thus allows detecting if bottle 3, i.e. the main container of the pump system, is empty or not. If the bottle is not detected as being empty, micro-pump system 23 continues to operate and supplies liquid from bottle 3 to refill 1. However, if bottle 3 is detected as being empty (indicated as branch “Y” in FIG. 6), micro-pump system 23 is switched off by system controller 25 and an empty bottle indicator 29 is switched on to alert the user to change bottle 3. To avoid overflow of refill 1, it is detected, in a similar manner, whether refill 1 is full or not, again by an appropriate time-frequency response signal analysis. If refill 1 is not full (“N”-branch in FIG. 6), the pumping operation process returns to the initial step of analyzing the response signal, and the process repeats until either bottle 3 is empty or refill 1 is full. Once refill 1 has been detected as being full, a refill full indicator 29 may be switched on to inform the user that the refill is ready for portable use and the pumping operation process stops. Also, an empty detection can be performed in this manner, so the micro-pump system 23 can be stopped to prevent micro-pump destruction or inefficient pumping.

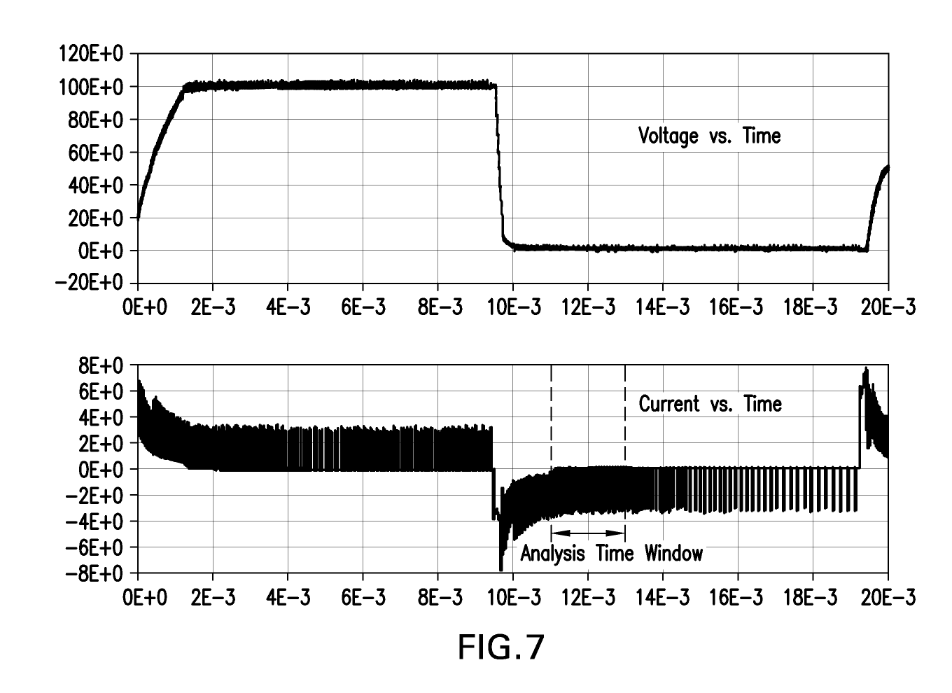

FIG. 7 shows an example of a time domain voltage and current of the micro-pump system used for controlling the refilling operation of the refilling in the system according to the present invention. As explained above, the band-passed filtered envelope analysis time window of the current generated by the micro-pump 23 is representative of the presence of liquid in bottle 3.

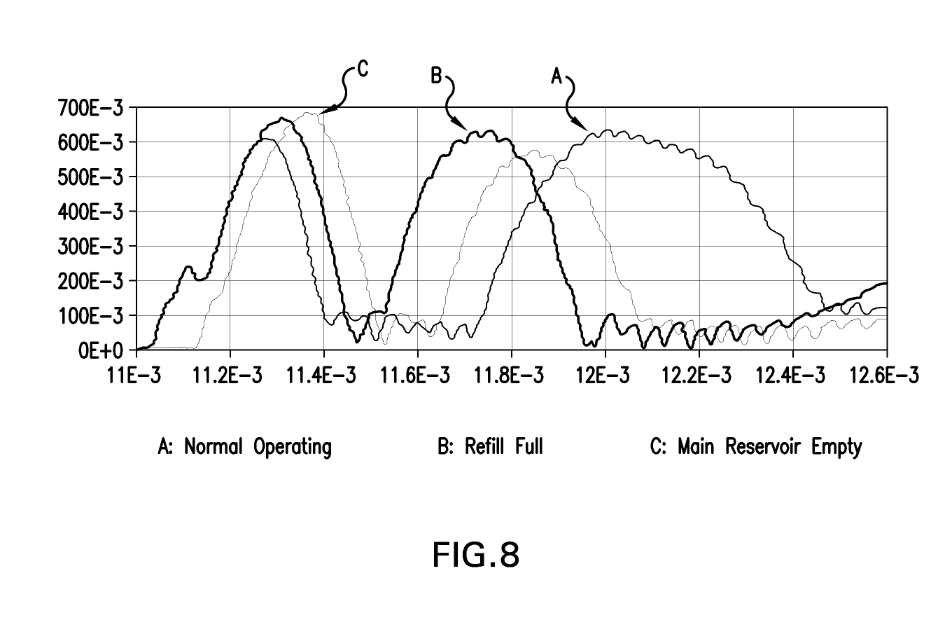

FIG. 8 shows examples of the analysis time-window response signal to detect the different states. As shown by signal “A”, there is a normal pumping operation, i.e., bottle 3 is not empty and refill 1 is not full.

Signal “B” shows the detection of the refill being full and signal “C” shows that bottle 3 is detected as being empty. This example demonstrates that the transient acoustic and mechanical vibrations due to the fast displacement induced by a micro-pump voltage variation of 100V or more have different shapes and delays for the three cases A, B and C.

By using these detection methods, the bottle empty status and the refill full status can be detected. Indeed, as can be seen from FIG. 8, the empty state (signal “C”) and full state (signal “B”) can be differentiated by an appropriate time-frequency analysis.

Having described now the preferred embodiment of this invention, it will be apparent to one of skill in the art that other embodiments incorporating its concept may be used. It is felt, therefore, that this invention should not be limited to the disclosed embodiments, but rather should be limited only by the scope of the appended claims.

### LEGEND OF CHARACTER REFERENCES

### 1: Refill

### 2: Docking cap

### 3: Bottle

10: Refill package

### 11: Refill tag

20: Refill dock
20′: Refill fluidic interface
21: Bottle fluidic interface
21′: Bottle dock
22: Electronic circuit board

### 23: Micro-pump

24, 24′, 24″: each corresponds to a non-contact tag reader
25: System process (system controller)
26: Power supply
27: Power management circuit
28: Solar module
29: indicators
30: Bottle neck

### 31: Bottle tag

32: Dip-tube

1. A refillable liquid cartridge system comprising:
(a) a main container containing liquid;
(b) a docking cap that controls liquid flow from the main container to a refillable cartridge, wherein the main container is disposed to provide the liquid contained therein to the refillable cartridge and the main container is mounted on the docking cap;
(c) a refillable cartridge operable as a portable spray device and mounted on the docking cap;
(d) a power supply disposed to power the docking cap, wherein the docking cap comprises
(i) a micro-pump system; and
(ii) a system controller operable to control the micro-pump, and wherein the micro-pump system is operable to pump the liquid from the main container to the refillable cartridge and to detect an empty state of the main container and a full state of the refillable cartridge.

2. A refillable liquid cartridge system according to claim 1, wherein the micro-pump system operates to detect combined time dependant acoustic and mechanical vibrations generated by flow of the liquid, and to provide electric signals to the system controller, and
wherein the system controller operates to analyse the electrical signal in order to determine the state of the liquid flow.

3. A refillable liquid cartridge system according to claim 1, wherein the refillable cartridge is provided with a refill package that receives the refillable cartridge and is adapted to fit into a refill dock of the docking cap, and the main container is provided with a bottle neck that receives the main reservoir and is adapted to fit into a bottle dock of the docking cap.

4. A refillable liquid cartridge system according to claim 3, wherein the refill package comprises a first tag for identification of the refillable cartridge.

5. A refillable liquid cartridge system according to claim 4, wherein the bottle neck comprises a second tag for identification of the main container.

6. A refillable liquid cartridge system according to claim 5, wherein the first tag and the second tag are non-contact tags, and the docking cap further comprises a non-contact tag reader coupled to the system controller and operable to read the first tag and the second tag, and wherein the system controller is operable to start the micro-pump system as a function of an output of the non-contact tag reader.

7. A refillable liquid cartridge system according to claim 3, wherein the refill dock comprises a refill fluidic interface having a first valve means regulating liquid flow to the refillable cartridge, and wherein the bottle dock comprises a bottle fluidic interface having a second valve means regulating liquid flow from the main container.

8. A refillable liquid cartridge system according to claim 1, wherein the docking cap is provided with a visual indicator that indicates at least one of a state of the main container, a state of the refillable cartridge, and a state of the power supply.

9. A refillable liquid cartridge system according to claim 1, wherein the docking cap further comprises
(iii) a solar module operably connected to generate power to recharge the power supply.

10. A refillable liquid cartridge system according to claim 1, wherein the liquid is perfume.

11. A refillable liquid cartridge system according to claim 1, wherein the micro-pump system is a piezoelectric micro-pump system having a piezoelectric actuator.

12. A refillable liquid cartridge system according to claim 2, wherein the refillable cartridge is provided with a refill package that receives the refillable cartridge and is adapted to fit into a refill dock of the docking cap, and the main container is provided with a bottle neck that receives the main reservoir and is adapted to fit into a bottle dock of the docking cap.

13. A refillable liquid cartridge system according to claim 12, wherein the refill package comprises a first tag for identification of the refillable cartridge.

14. A refillable liquid cartridge system according to claim 3, wherein the bottle neck comprises a first tag for identification of the main container.

15. A refillable liquid cartridge system according to claim 12, wherein the bottle neck comprises a first tag for identification of the main container.
